(19) United States
(12) Patent Application Publication
(10) Pub. No.: US 2007/0068098 A1
(43) Pub. Date: Mar. 29, 2007

(54) Modular millwork

(76) Inventors: Burke de Briere, Bothell, WA (US); Mark Willsie, Redmond, WA (US); Alan Bridgman, Snohomish, WA (US)

Correspondence Address: Amin & Turocy, LLP;National City Center, 24th Floor, 1900 E. 9th Street, Cleveland, OH, 44114, US

(21) Appl. No.: 11/238,701

(22) Filed: Sep. 29, 2005

(51) Int. Cl. E06B 1/04; E06B 3/00

(52) U.S. Cl. 52/211; 52/204.55

(57) ABSTRACT

A modular millwork finishing or trim kit is provided. The modular finishing kit can include a trim unit and a set of connectors or retaining means. The trim unit can be shaped to outline an opening, for example, a window opening. The set of connectors can include one retaining means mounted to the window frame and/or rough opening. Another compatible retaining means can be mounted to the millwork trim kit. In operation, the retaining means attached to the millwork trim kit can facilitate removable, or permanent, engagement to the compatible retaining means positioned on the window frame and/or rough opening.

### TECHNICAL FIELD

This invention relates to decorative molding and more particularly to systems and methodologies of manufacture and application of millwork assemblies for use in finish carpentry applications.

### BACKGROUND

A carpenter is a skilled craftsman who performs a wide range of woodworking tasks. For example, a carpenter can perform projects that range from making furniture to constructing complete buildings of wood. As such, carpentry work generally involves significant precision, skill and manual labor.

Much of carpentry's knowledge is gained through on-the-job experience. A rough carpenter is one who does rough carpentry; that is, framing, roofing, and other structural or other large-scale work that need not be finely joined or polished in appearance. On the other hand, a finish carpenter is one who performs finish carpentry; that is, cabinetry, furniture making, fine woodworking, instrument making or other carpentry where exact joints and minimal margins of error are important.

Today, homeowners have exhibited an increased emphasis on “do-it-yourself” (DIY) skills. For example, DIY-based big-box stores and supply houses have emerged to accommodate this growing trend of performing many traditionally skilled tasks without the support of the skilled journeyman. Some areas of carpentry is included in these tasks.

Conventionally, a homeowner would contact a skilled craftsman (e.g., carpenter) to perform home improvements and projects that require specialized knowledge and skill. The ever-increasing emergence of the DIY stores has led to many homeowners and “do-it-yourselfers” to tackle projects traditionally left to the skilled craftsman. However, there exist skills and projects that continue to be left to the craftsman; finish carpentry is one of these skills.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a modular millwork assembly that can be removably applied to a window opening. The modular millwork assembly can enable a “do-it-yourselfer” to achieve professional results without the possessing the skills and/or tools of a trained craftsman. Additionally, the modular millwork assembly described herein can reduce costs and time involved with traditional millwork installations.

The modular finishing kit can include a trim unit and a set of connectors or retaining means. The trim unit can be shaped to outline an opening, for example, a window opening. The set of connectors can include one retaining means mounted to the window frame and/or rough opening. Another compatible retaining means can be mounted to the millwork trim kit. In operation, the retaining means attached to the millwork trim kit can facilitate removable, or permanent, engagement to the compatible retaining means positioned on the window frame and/or rough opening.

In still another aspect, a modular millwork assembly can be applied to a door opening. For example, the modular millwork assembly can quickly and easily enable a layman to apply a professional finished look to an installed door. Yet another aspect is directed to a fireplace or hearth application. Again, a professional result can be achieved without finish carpentry skills and availability to specialized tools.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a perspective view of a window assembly that includes a modular millwork kit in accordance with a disclosed aspect of the invention.

FIG. 2A illustrates an exemplary slide-lock retaining means in accordance with a disclosed aspect of the invention.

FIG. 2B illustrates an exemplary pin retaining means in accordance with an aspect of the invention.

FIG. 3 illustrates a perspective view of two slide-lock retaining means diagonally mounted onto a trim assembly in accordance with an aspect of the invention.

FIG. 4 illustrates an exemplary application of a window installation in accordance with an aspect of the invention.

FIG. 5 illustrates an exemplary installation of a modular trim assembly having retaining means mounted thereon in accordance with an aspect of the invention.

FIG. 6 illustrates an alternative aspect that employs a modular trim assembly on a door opening in accordance with an aspect of the invention.

FIG. 7 illustrates an alternative aspect that employs a modular trim assembly on a fireplace in accordance with an aspect of the invention.

FIG. 8 illustrates an alternative aspect that employs a decorative and/or theme-oriented modular trim assembly accordance with an aspect of the invention.

FIG. 9A illustrates an alternative taper-slide retaining means in accordance with a disclosed aspect of the invention.

FIG. 9B illustrates an exemplary adjustable pin retaining means in accordance with an aspect of the invention.

FIG. 10 illustrates an alignment tool that facilitates placement of retaining means in accordance with an aspect of the invention.

FIG. 11 illustrates a perspective view of an alignment tool in operation in accordance with an aspect of the invention.

### DETAILED DESCRIPTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

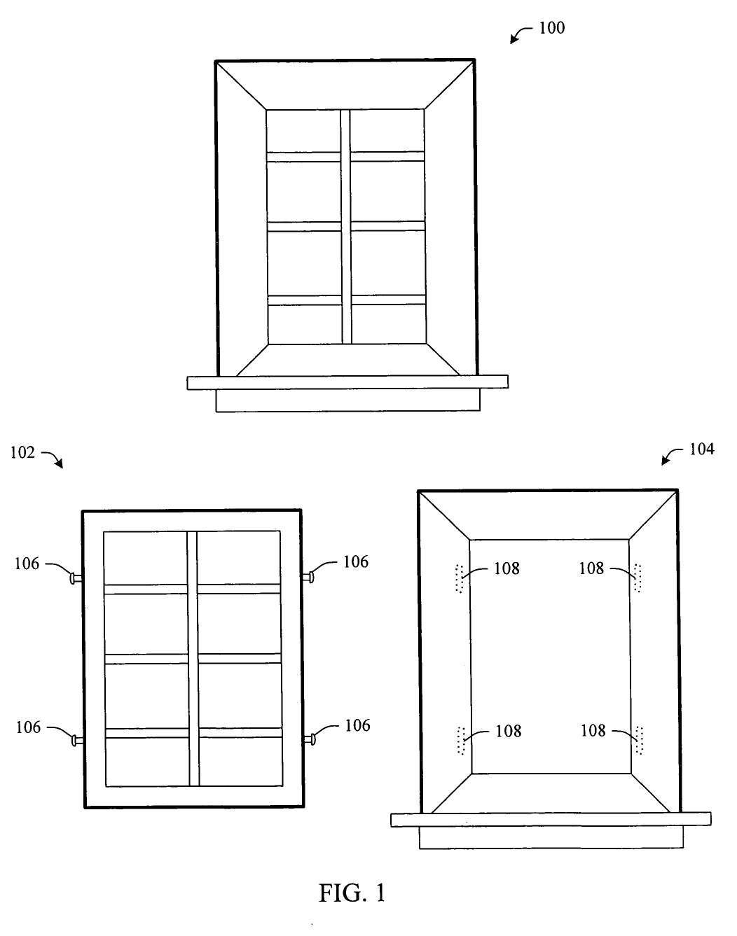

Referring initially to the drawings, FIG. 1 illustrates a millwork assembly 100 in accordance with an aspect of the invention. As illustrated, millwork assembly 100 can include a window assembly 102 and a framing or trim kit 104. The disparate assemblies 102, 104 are equipped to connect to each other in a secure manner while allowing ease of assembly and disassembly. It is to be understood that while the embodiments shown and described herein illustrate a framing or trim kit 104 that is substantially predefined in size, the size of the trim kit 104 can be adjustable, such as for use with larger openings, openings with unique shaping, or for other applications, etc. depending on the preference of the user. In addition or alternatively, the trim kit 104 can be supplied as individual pieces or as an assembly.

More particularly, window assembly 102 can include 1 to M, male pins or connectors, where M is an integer. It is to be understood that 1 to M connectors can be referred to individually or collectively as connectors 106. In one aspect, four connectors are positioned on opposite edges of the window frame 102 as illustrated. Additionally, the connectors 106 (e.g., pins) can be placed equidistantly from the centerline of each vertical side of the frame 102. However, it is to be understood that, depending on the particular application, the connectors 106 can be placed in any position on the frame 102 even if such positioning is not equidistant from the centerline. Alternatively or in addition, connectors 106 can be placed on the top and or bottom of the frame 102 in a similar manner as that shown and described herein. For example, for an opening that has a wider width than height it might be more practical to place the connectors 106 on the top and bottom rather than, or in addition to, the sides of the opening. By way of illustration and not limitation, a window may be 2 feet high and 6 feet wide. In this example, having connectors 106 along the width of the window allows for placement of more connectors than if the connectors 106 were placed on the sides of the window.

Although the aspect illustrated in FIG. 1 employs four male connector pins, it is to be understood and appreciated that any number of male connector pins 106 can be employed without departing from the novelty of the invention. For example, a small opening might require a lesser number of connectors 102 while a larger opening might require more connectors 102. Additionally, it is to appreciated that any type of male (or female) connector can be positioned on the window frame 102 that is capable of mating with a compatible connector positioned on the framing or trim kit 104.

Referring now to the trim kit 104, 1 to M connectors can be positioned on the inner flange portion of the assembly. Continuing with the example above, four female connectors can be positioned on the outer frame of the trim kit 104. As described with respect to the window frame 102, the connectors 108 can be positioned, according to one embodiment, equidistant from the centerline of the vertical sides of the trim kit 104 as illustrated. It is to be understood that the placement of the female connectors 108 is substantially similar to the placement of the male connectors 106. While male connectors 106 are shown on the window frame 102 and female connectors 108 are illustrated on the trim kit 104, it is to be understood that the female connectors 108 can be on the window assembly 102 and the male connectors on the trim kit 104. Additionally, while specific connectors 106 and 108 are illustrated, the disclosed embodiments work equally well with any of a plurality of suitable connecting means, provided there is an easy way to assemble and/or disassembly the unit while securely engaging the unit to the opening.

The connectors 106, 108 are situated on each assembly 102, 104 such that the assemblies 102, 104 can easily connect to form a single finished unit 100, allowing anyone to install regardless of skill and/or knowledge. As described above, conventionally, finishing millwork requires the skill and craftsmanship of a trained professional. Additionally, specialized tools are oftentimes required in order to achieve a tight and precise frame. For example, a miter saw, jointer and planer are often needed to achieve a professional product. Unfortunately, the layman does not often have access to these tools and/or possess these skills, thus, the embodiments disclosed herein allow usage by anyone, even without access to such tools and/or skills.

Although the aspect illustrated in FIG. 1 depicts a rectangular window assembly, it will be appreciated that the novel features and functionality described herein can be applied to a plurality openings having a plurality of shapes (e.g., square, round, octagonal, etc.) without departing from the novelty and usefulness of the modular design. For example, the disclosed embodiments can be applied to applications such as exterior doors, interior doors, fireplaces, garage or shed doors, other recessed openings, etc. Theses alternative embodiments will be described in greater detail infra. As well, it is to be understood and appreciated that the trim assembly can be manufactured from any rigid material including, but not limited to, wood, metal, plastic, synthetics, fiberglass, polymers, etc.

The modular millwork assembly 100 can be particularly useful to easily alter the aesthetic appearance of a window opening. For example, the modular millwork assembly 100 can be useful to change a particular style of millwork (e.g., colonial, ranch) to coincide with a user preference. Traditionally, because millwork was attached with nails and the like, replacing existing millwork would result in damage to the surrounding plaster and opening. The subject millwork assembly 100 enables quick and easy installation and/or replacement of decorative trim. Moreover, the modular millwork assembly can be useful in new construction and remodeling projects to greatly enhance productivity, lower cost and enable a “do-it-yourselfer” to achieve professional millwork results without possessing the skills or having the tools otherwise necessary.

By way of illustration and not limitation, the millwork assembly 100 can be also applied to windows along the exterior of a house, building, or other structure. This would be particularly useful for holiday decorations, such as for Halloween. A user can apply millwork assembly 104 to all or some windows that have a Halloween theme to alter the appearance of the structure, such as to make it appear “haunted.” After the holiday, the user may not desire the structure to have the themed appearance and may easily remove the millwork assembly 104 and replace it, altering the appearance of the structure without having to make drastic (and expensive) changes.

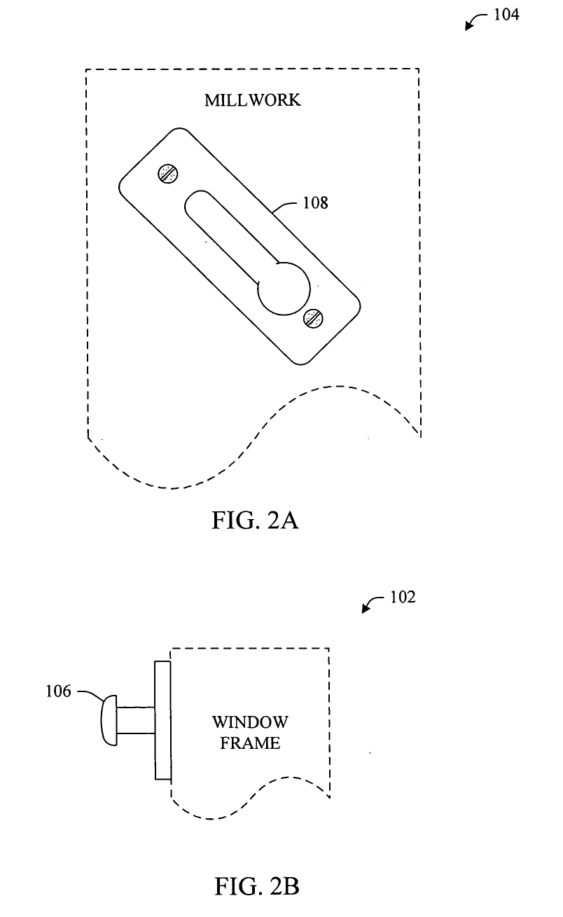

Turning now to FIGS. 2A and 2B, a more detailed view of exemplary connectors 106, 108 is shown. More particularly, FIG. 2A illustrates a perspective view of a female connector 108 that can be mounted on the inner edge of the trim assembly frame 104. As shown, a keyhole slide assembly connector can be employed in accordance with an aspect. This keyhole slide can be tapered such that, when coupled with a male connector pin 106, the connection is tight and a proper alignment is obtained. The keyhole slide has a first end 202 and a second end 204 that include respective fastening means 206 and 208 that fasten or secure the female connector 108 to the trim kit 104. The first end 202 further comprises a catch 210 that can be sized slightly larger than a corresponding male connector 106 of the window frame 102. The catch 210 is a similar shape as the male connector 106. Extending from the catch 210 to about the second end 204 is an opening that is a similar size and shape as the catch 210, however, the material of the female connector 108 can cover a percentage or substantial portion of the opening, giving the appearance of a reduced or smaller receiver 212. The catch 210 and receiver 212 can have a depth sized to receive a head 220 of the male connector 106.

FIG. 2B illustrates a male pin connector 106 that can be mounted on the outer edge of the window assembly 102 or other opening. Additionally, as will be described below, the male connector pin 106 can be positioned on the inside of a rough opening. The male connector 106 can have a head portion 220 and a shaft 222. The head portion 220 can be larger than the shaft 222. The head portion 220 and shaft 222 do not have to be the same shape, provided there is no part of the shaft 222 that is larger than the head portion 220. The head 220 can be sized smaller than the receiver 212 of the female connector 108. The shaft 222 can be connected at one end to the head 220 and at its second end to an adjustable mount 224. The adjustable mount 224 is operatively connected to the frame 102 and allows for adjustment of the locking mechanism 106 and 108 within a specification tolerance. Thus, if the female connector 106 is not in perfect alignment with the male connector 108, the adjustable mount 224 can be moved to overcome the alignment deficiencies. The male connector 106 can be removably engaged into the female connector 108 illustrated in FIG. 2A. Accordingly, the two assemblies 102, 104 can be connected forming a single finished unit. It is to be appreciated that other connectors known in the art can be employed with this concept to form a removable and/or permanent bond between the assemblies 102, 104.

The operation of the connecting means 106 and 108 will now be discussed in order to fully appreciate the invention. While a window opening is described, the disclosed features work equally well with any type of opening. In a window application, the window frame 102 can be installed in the opening. The window frame 102 can be separate from the actual window itself or it may be an integral portion of the window. The trim kit 104 is placed in removable engagement with the frame 102 such that the catch 210 of the female connector 102 engages the male connector 106. The head 220 is inserted into and substantially within the catch 210. The trim kit 104 is then slid forward (or another appropriate direction) to move the male connector 106 from the first end 202 to a second end 204, engaging the male connector in the receiver 212. Thus, with the trim kit 104 in position, the male connector 106 is operatively engaged, providing a secure fit. It is to be appreciated that the other connectors of the window frame 102 and trim kit 104 operate in a substantially similar fashion and are operatively engaged at a substantially similar time. That is to say, the placement of the female connector 108 in relationship to the trim kit 102 is such that when the trim kit 108 is placed and then moved in a direction to engage the male connector 106, all connectors are operatively engaged.

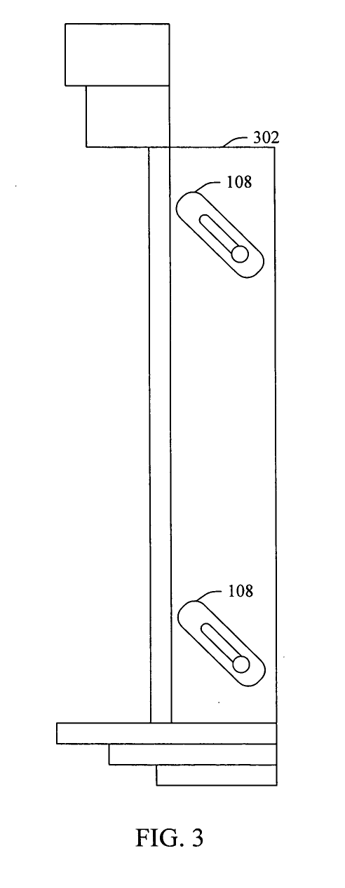

Referring to FIG. 3, in another aspect, male pin connector 106 (not shown) can be mounted on the inside of a rough opening prepared to accept a window unit 102. FIG. 3 illustrates a side view of this alternative aspect. Accordingly, the window 102 can be installed into the opening leaving the pin 106 (not shown) inwardly protruding on a plane even with the window. In order to effect engagement with the pins 106 (not shown), the trim assembly can include compatible female connectors (e.g., 108) mounted on the outside of the assembly frame. As shown in FIG. 3, a millwork assembly 302 can be equipped with connectors 108 compatible of mating with connectors mounted on the inner edge of the rough opening.

In an alternative aspect of the application of connectors 108, a user can employ a routing means to countersink connectors 108 beneath the surface of millwork assembly 302. As such, this countersunk application can provide for a guide when attaching the millwork assembly 302 to a frame thereby enhancing alignment and/or ease of application.

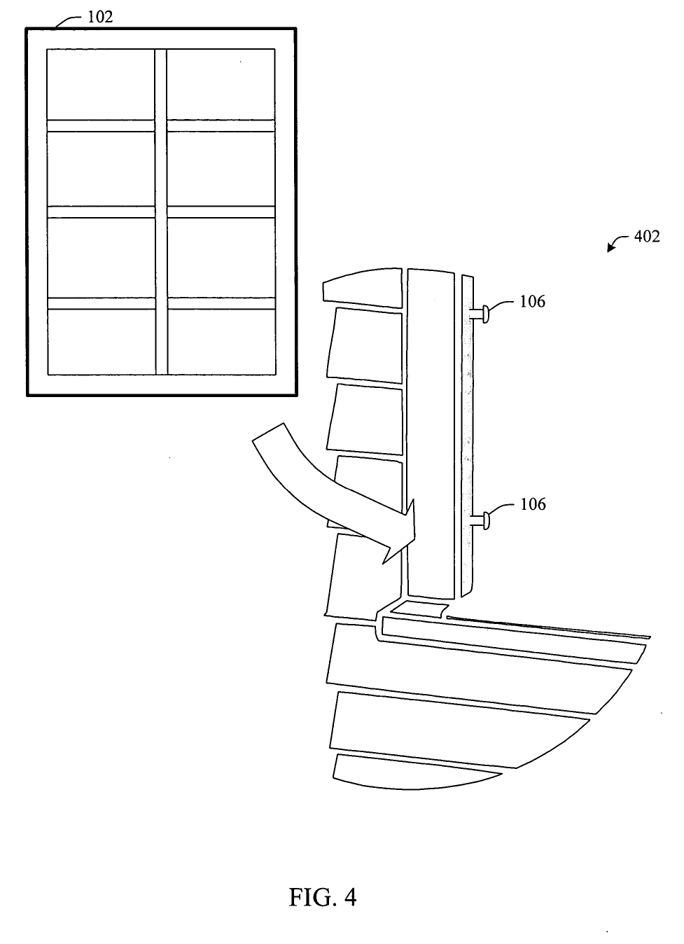

In operation, FIG. 4 illustrates a window assembly 102 being installed into a window opening 402. As shown, the window assembly 102 can be installed into the opening 402 prior to installation of any millwork or trim assembly. As illustrated, the window assembly 402 can be installed from the exterior of the structure. Male connectors 106 can be positioned on the inner face of the rough opening frame as shown.

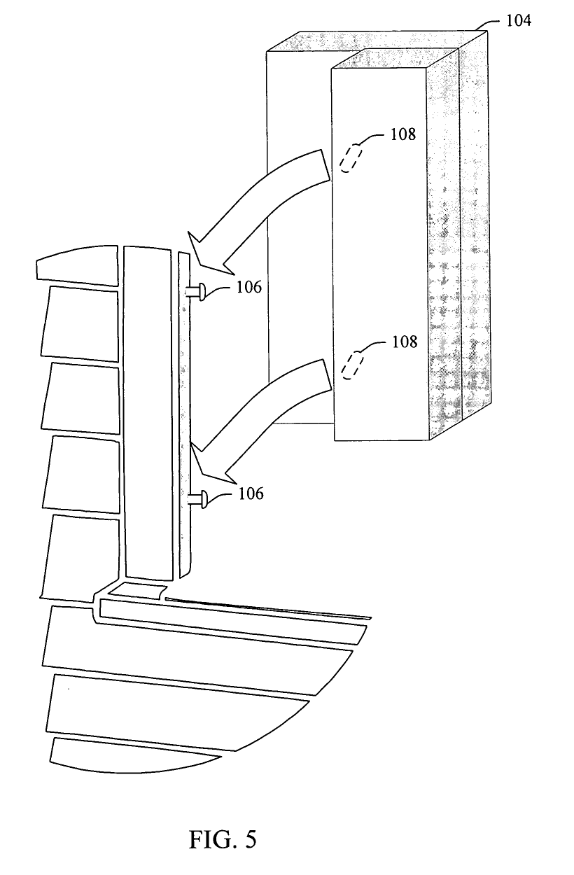

FIG. 5 illustrates a configuration of applying a finished molding or millwork assembly 104. Millwork assembly 104 can be equipped with compatible female connectors 108 which can removably or permanently mate to male connectors 106 as illustrated. Accordingly, millwork assembly 104 can be fit into place thereby finishing the interior of the window opening.

As described above, finished carpentry requires precise talent and skill not often possessed by laymen. For this reason, the subject millwork assembly 104 can be pre-manufactured and equipped with connectors 108 capable of interfacing and/or engaging with compatible connectors (e.g., 106) mounted on the inner portion of a rough opening 402.

In one aspect, the finished millwork assembly 104 can be assembled by connecting individual lengths of wood trim (e.g., mitered and unmitered). In one aspect, the individual lengths can be joined together forming a corner; usually both sides are bevelled at a 45-degree angle to form a 90-degree corner, although other angles are contemplated.

In another aspect, the finished millwork assembly 104 can be constructed of a composite material. In this example, individual lengths of composite material can be employed to construct the finished millwork assembly frame 104. As well, a single composite assembly can be manufactured (e.g., plastic injection molding) to effect the modular millwork frame 104.

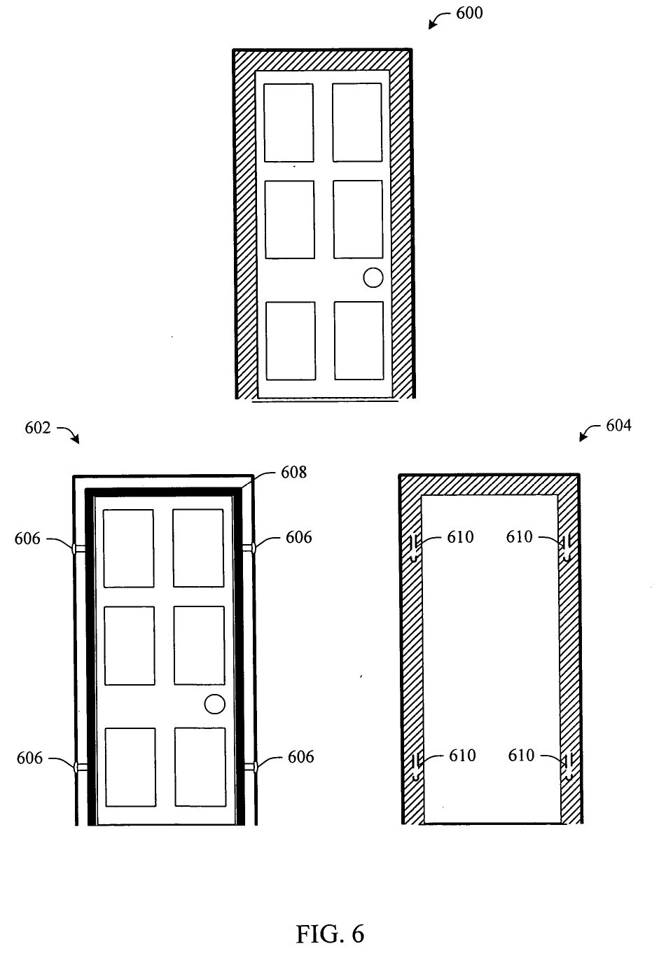

Turning now to FIG. 6, an alternative application of the subject modular millwork assembly is shown. More particularly, a finished assembly 600 is shown. Generally, finished assembly 600 can include a door assembly 602 and a modular millwork assembly 604. Each of these sub-assemblies, 602, 604 is described in greater detail below.

Referring first to the door assembly 602, as described with reference to the window millwork aspect above, connectors 606 can be positioned onto the perimeter of the door assembly 602 as shown. In one example, these connectors 606 can be male pin-type connectors positioned equidistant along the vertical lengths of the frame 608. Although FIG. 6 illustrates four pin connectors located equidistantly and protruding inward from frame 608, it is to be understood and appreciated that any number of pins 606 can be employed in alternative aspects. As well, all, or a subset of pins 606 can be positioned throughout the horizontal length of the frame 608.

Turning now to the millwork assembly 604 of the example, this assembly is a finish frame that can be constructed of three individual lengths of millwork; one horizontal (e.g., top) length and two vertical (e.g., side) lengths. The lengths can be connected employing any means known in the art including, but not limited to, nails, glue, brackets or the like. As well, the joints can be formed by flat cutting or miter cutting (e.g., 45 degree) the ends of the lengths.

Connectors 610 can be included and mounted on the inner portion of the millwork assembly 604. In other words, connectors 610 can be connected on the inner portion of the assembly 604 such the connectors 610 align with the connectors (e.g., pins 606) mounted on the inward portion of the frame 608. In one example, the connectors 608, 610 are male and female connectors respectively. As described with reference to FIG. 3, the connectors 610 can be arranged in a sloping (e.g., diagonal) manner such that gravitational forces can assist in application and retention of the millwork assembly 604 upon the frame 608.

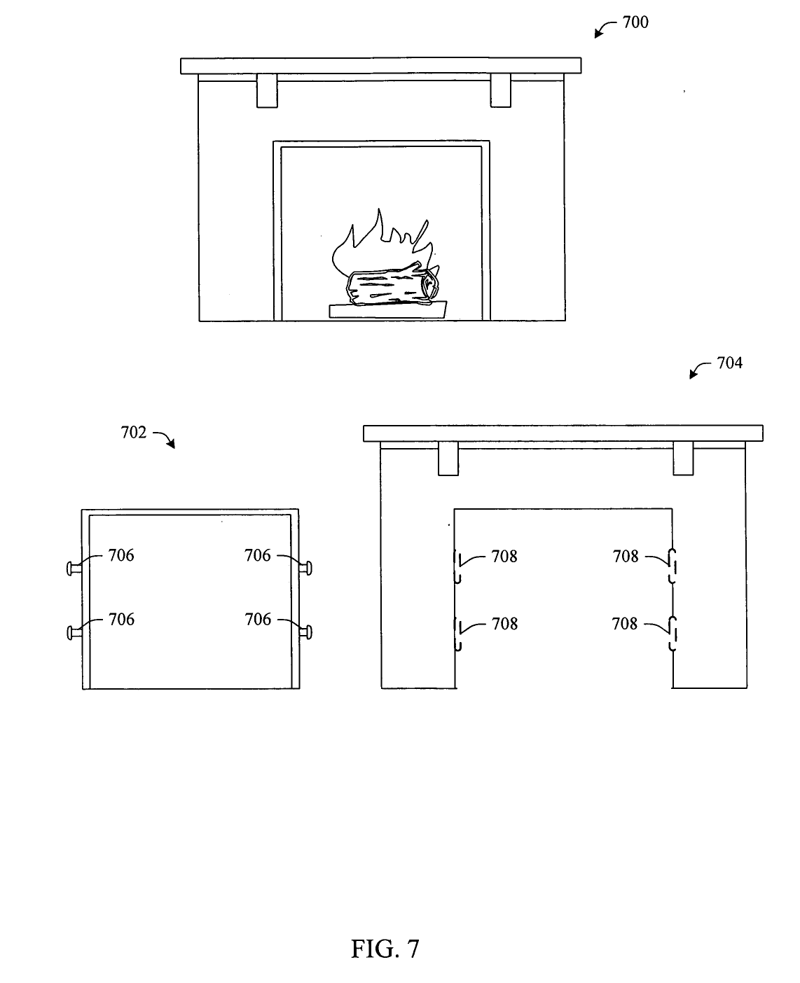

Yet another aspect of the invention is illustrated in FIG. 7. In particular, a hearth assembly 700 is shown. As shown, hearth assembly 700 can generally include a firebox assembly 702 and a mantle assembly 704. Consistent with the discussion of the window and door assemblies above, the firebox assembly 702 and the hearth assembly 700 can be equipped with compatible connectors 706, 708 thus enabling the two assemblies 702, 704 to interconnect. It is to be appreciated that the units can permanently or removably interconnect to form the finished hearth assembly 700.

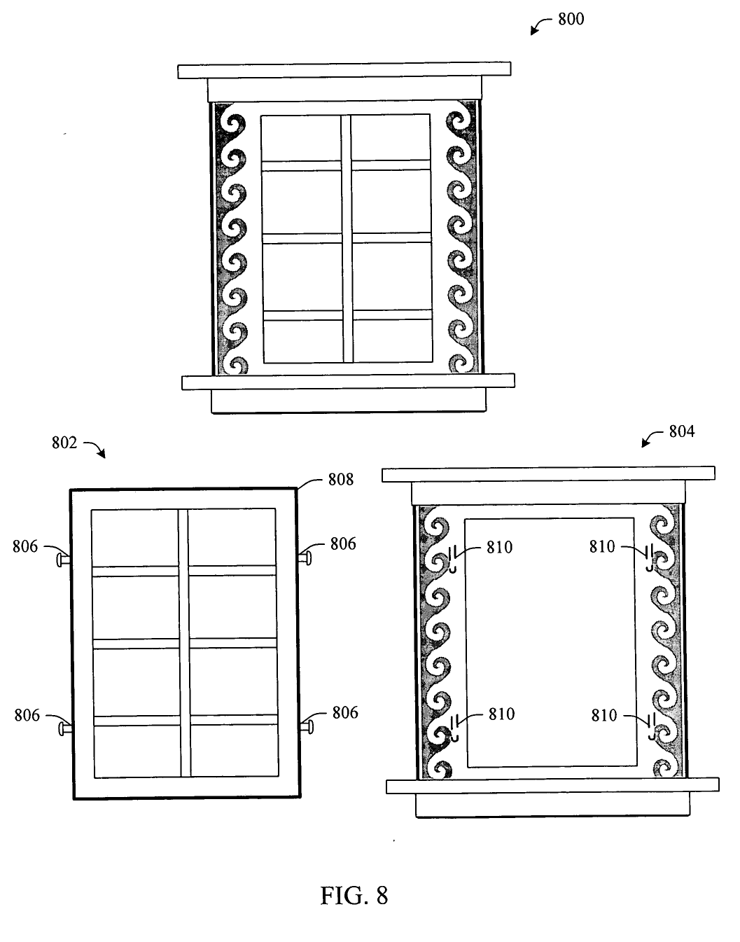

Referring now to FIG. 8, an alternative aspect of a window millwork assembly 800 is shown. As traditional millwork assemblies are fabricated from connected lengths of decorative wood or trim, it is to be understood that other aspects exist whereby millwork assemblies can be constructed utilizing other non-traditional materials such as molded plastic, fiberglass, metal or the like. Millwork assembly 800 can include window assembly 802 and a decorative trim kit 804.

As can be seen in FIG. 8, connector pins 806 can be applied to the outer portion of the window frame 808. It will also be appreciated that these, or similar, connector pins 806 can be applied to the inward portion of the rough opening frame as described with reference to FIG. 4 supra.

In either case, the decorative trim kit 804 can be equipped with compatibly mounted and arranged connectors 810. Thus, the decorative trim kit 804 can be interconnected to window frame 808 (or, rough opening (not shown)) thereby creating an autonomous unit, window millwork assembly 800.

The window millwork assembly 800 particularly illustrates a decorative manner in which window trim kit 804 can be employed. For example, theme-based assemblies can be manufactured and applied as desired (e.g., interiorly or exteriorly). By way of example, holiday themes such as the Thanksgiving, Christmas, Hanukkah, or the like can be applied to (e.g., printed upon) the window trim kit 804. As such, the ease of installing and uninstalling the window trim kit 804 can be used to change an appearance in view of a holiday.

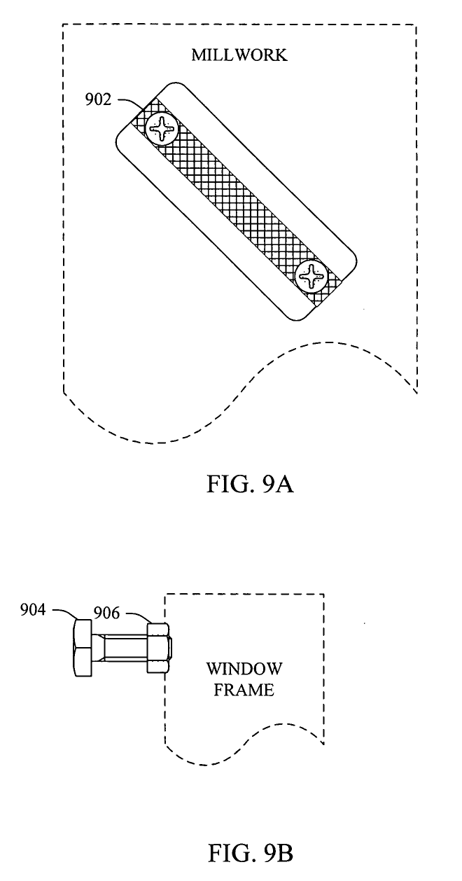

Illustrated in FIGS. 9A and 9B are alternative retaining means in accordance with an aspect of the modular millwork assembly. More particularly, FIG. 9A illustrates a tapered slide assembly 902. The tapered slide assembly 902 can accept the head of the pin 904 illustrated in FIG. 9B. As shown, the millwork can be equipped with the tapered slide 902 such that when the head of the pin 904 is inserted into the tapered slide 902, the head becomes wedged or lodged into the slide such that the millwork remains securely in place.

With continued reference to FIG. 9, pin 904 can be adjustable to facilitate proper engagement with taper slide assembly 902. As well, a lock nut 906 is illustrated as a part of pin 904. This lock nut 906 can be loosened to enable the pin 904 to be adjusted in any direction. Once adjusted, the lock nut 906 can be tightened to secure and maintain the adjustment. It is to be understood that other aspects can include self or auto-adjusting retaining means applied to either, or both, connectors 902, 904. These auto-adjusting retaining means are to be included within the scope of this disclosure and claims appended hereto. In addition to the adjustable functionality of the pin 904, it is to be appreciated that a shim, or group of shims, can be applied as needed to either connector 902, 904 in order to effect proper alignment and engagement of the retaining means.

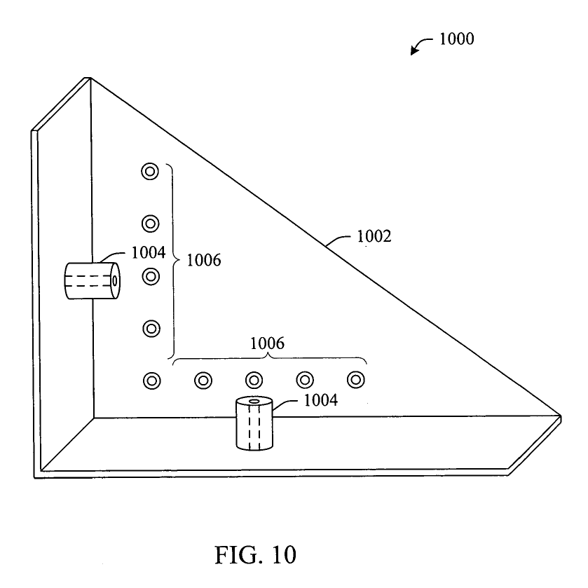

FIG. 10 illustrates an exemplary alignment tool or jig 1000. Generally, this jig 1000 facilitates alignment and/or placement of the retaining means upon the window or rough opening. In operation, a user can employ the jig 1000 having a triangular housing 1002 to align the drill guides 1004 in order to pinpoint placement of the retaining means (e.g., pins). This alignment is particularly important as the alignment can be different for different manufactured assemblies.

In order to comply with different manufacturers, alignment pin guides 1006 are supplied. These alignment pin guides 1006 can accept an alignment pin (not shown) thus positioning the jig 1000 for proper retaining means placement. In operation, once aligned, a user can drill a guide hole through the drill guide 1004 into a window frame or rough opening. Accordingly, this hole can be used to position the retaining means (e.g., pins).

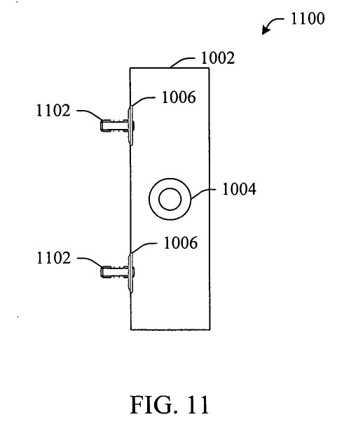

FIG. 11 is a perspective view of jig 1000. This perspective view of jig 1000 illustrates guide pins 1102 placed through the alignment pin guides 1006 of FIG. 10. It is to be appreciated that any combination of alignment pin guides 1006 can be employed to determine proper placement of retaining means. In operation, a user would insert guide pins 1102 corresponding with a particular window type and/or manufacturer. For example, a table can be provided that identifies which holes to insert the guide pins 1102 in order to achieve proper placement.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A modular millwork finishing kit, comprising:
a trim unit shaped to outline an opening; the opening is defined by a frame having a front surface, a rear surface, an inner surface and an outer surface; and
a first connector positioned on the inner surface of the frame and a second connector positioned on an outer surface of the trim unit, the first connector and second connector detachably couple to affix the trim unit to the front surface of the frame.

2. The system of claim 1, the opening is a window opening.

3. The system of claim 1, the opening is a door opening.

4. The system of claim 1, the opening is a firebox and the trim unit is a mantle unit.

5. The system of claim 1, the first connector comprises a male portion and the second connector comprises a female portion; the male portion detachably mates to the female portion to affix the trim unit to the front surface of the frame.

6. The system of claim 5 the female portion is recessed into an outer surface of the trim unit and the male portion is positioned on the inner surface of the frame.

7. The system of claim 1, the first connector is at least one of a clasp, a slide, a snap, a press-stud, a catch and a clip.

8. The system of claim 7, the first connector is an adjustable connector.

9. The system of claim 1, the trim unit comprises a plurality of members, the plurality of members interconnect to form a continuous length that outlines the opening.

10. The system of claim 1, the trim unit is a single unit that outlines the opening.

11. A method of installing a trim unit around an opening, comprising:
aligning a jig to an inner surface of a frame that defines the opening, the jig includes one or more alignment pins and a drill guide;
drilling a hole through the drill guide;
installing a male connector into the hole; and
removably connecting the trim unit to the male connector.

12. The method of claim 11, further comprising installing a female connector to an outer surface of the trim unit, the female connector mates with the male connector to removably connect the trim unit to the frame.

13. The method of claim 12, the act of installing a female connector comprises routing the frame to recess the female connector into the outer surface of the frame.

14. The method of claim 13, further comprising adjusting the male connector to compatibly connect to the female connector.

15. The method of claim 13, further comprising adjusting the female connector to compatibly connect to the male connector.

16. A system that facilitates installing a molding kit, comprising:
means for determining a location for a first connector and a location for a second connector;
means for affixing a first connector to the inner surface of a frame that defines an opening of a window;
means for affixing a second connector to the outer surface of the molding kit; and
means for aligning the first connector with the second connector to install the molding kit.

17. The system of claim 16, further comprising:
means for adjusting at least one of the first connector and the second connector to facilitate a proper alignment of the first connector to the second connector.

18. The system of claim 17, further comprising means for recessing the second connector into the outer surface of the molding kit.

19. The system of claim 18, the means for recessing is a router.

20. The system of claim 19, the molding kit is a wooden millwork assembly.
